(19) United States
(12) Patent Application Publication
(10) Pub. No.: US 2024/0415323 A1
(43) Pub. Date: Dec. 19, 2024

(54) AUTOMATIC WOK PAN

(71) Applicant: Liang Xu, Shenzhen (CN)

(72) Inventor: Liang Xu, Shenzhen (CN)

(21) Appl. No.: 18/220,843

(22) Filed: Jul. 12, 2023

(30) Foreign Application Priority Data
Jun. 13, 2023 (CN) 202321504028.X

(51) Int. Cl. A47J 36/16; A47J 37/10; A47J 43/044; A47J 43/07; A47J 43/08

(52) U.S. Cl. CPC A47J 36/165; A47J 37/108; A47J 43/044; A47J 43/0711; A47J 43/082

(57) ABSTRACT

The present invention relates to an automatic wok pan, which solve that technical problems that the existing automatic wok pan cannot be disassembled, is difficult to clean and cannot be opened when in use. The present invention discloses an automatic wok pan, the upper end of the pan body is provided with a force arm, the force arm and the shell are arranged on the pan body through the notches at the upper end of the pan body, the tail end of the transmission component is connected with a stirring component, and the stirring component is fixed in the center of the pan body through the force arm. A fixing buckle arranged on the notch and the detachable component on the force arm are mutually buckled and matched, so that the force arm can be detached or fixed on the pan body.

### CROSS-REFERENCE TO RELATED APPLICATIONS

This application claims priority to Chinese Patent Application No. 202321504028.X filed on Jun. 13, 2023, the entire contents of which are hereby incorporated by reference.

### TECHNICAL FIELD

The present application belongs to the field of cooking utensils, and in particular to an automatic wok pan.

### BACKGROUND

In the traditional cooking method, people have to operate it by themselves. Because people need to stir-fry constantly when cooking, they cannot cover the pan, and a lot of oil smoke will come out. People will feel choked or even uncomfortable when inhaling oil smoke. Even if there is a range hood, a lot of oil smoke will be adsorbed on the wall where cooking is done, which will affect the cleanliness of the kitchen and make it difficult to clean it. Although there are automatic wok pans in the market, or they simply do not have a pan cover, or they cannot be opened during use, it is impossible to open the lid to add ingredients when frying, and the ingredients of many dishes are added step by step according to how cooked the dishes are. If they are thrown away, the taste of the dishes will be easily affected, and because they are all integrated, they are not easy to clean, and they need to be plugged into commercial power, so they cannot be used on cookers such as induction cookers and gas stoves, and they are not convenient for outdoor use.

Publication (announcement) No.: CN204862609U (Publication (announcement) date: Dec. 16, 2015) discloses a utility model patent for an automatic wok pan, which includes a pan body 1, a heating device 2 and a stir-frying device 3; the bottom of the pan body 1 is flat, and the heating device 2 is installed below the pan body 1; the stir-frying device 3 includes a stirring device 4, a material adding device 5 and a control panel 6; the stirring device 4 comprises a stirring motor 7, a stirring shaft 8 and a stirring paddle 9, wherein the stirring motor 7 is positioned at the top of the stir-frying device 3, the stirring shaft 8 is mounted on the stirring motor 7; the stirring shaft 8 extends into the pan body 1, the stirring paddle 9 is mounted on the stirring shaft 8, and the material adding device 5 is positioned at the top of the stir-frying device 3; one end of the material adding device 5 extends into the pan body 1, and the control panel 6 is positioned at the top of the stir-frying device 3; a fixed hinge 10 is installed on the upper edge of the pan body 1, and the stir-frying device 3 is connected with the pan body 1 through the fixed hinge 10; the bottom surface of the stir-frying device 3 is tightly attached to the pan body 1; the length of the stirring shaft 8 extending into the pan body 1 is slightly less than the internal height of the pan body 1, and the number of the stirring paddles 9 is three pairs; the stirring paddles 9 are fixed at the lower part of the stirring shaft 8 through fastening screws 11, and the length of the stirring paddles 9 is slightly less than the flat bottom diameter of the pan body 1; the output end of the control panel 6 is connected with the stirring device 4, the material adding device 5 and the heating device 2 respectively, and the input end of the control panel 6 is connected with the input power line 12.

Although the present application patent can achieve the effect of automatic cooking, it is not easy to clean after cooking, and it needs to be plugged in for use, which is complicated. When using, because the lid cannot be opened, the ingredients and seasonings cannot be added with the cooking, which affects the taste of the dish.

### SUMMARY

The present application aims to provide an automatic wok pan to solve the technical problems that the existing automatic wok pan cannot be disassembled, is difficult to clean and the lid cannot be opened when in use.

In order to achieve the above purpose, the present application provides an automatic wok pan with the following specific technical solution:

An automatic wok pan includes a pan body, wherein the upper end of the pan body is provided with two notches; a force arm is arranged at the upper end of the pan body; a shell is arranged at the upper end of the force arm; the force arm and the shell are arranged on the pan body through the notches at the upper end of the pan body; the shell and the force arm are detachably fixed on the pan body through detachable components; the height of the force arm does not exceed the height of the notch of the pan body; a power supply is arranged at the right side in the force arm; the left side of the battery is connected with a motor, and the power supply and the motor are far away from the pan body; the other side of the motor is connected with a transmission component, the tail end of the transmission component is connected with a stirring component, and the stirring component is fixed at the center of the pan body through the force arm.

Preferably, the motor drives the stirring component through the transmission component.

Preferably, the force arm also includes a shell arranged on the upper surface; the automatic wok pan further includes circular grooves evenly distributed on the shell, fastening circular holes are arranged on the shell near the notches at both ends of the pan body, and push grooves are arranged on the notches near the pan body; clamping grooves are arranged on both sides of the lower end of the shell, clamping blocks corresponding to the clamping grooves are arranged on both sides of the upper surface of the force arm, and the upper surface of the force arm is also provided with fastening cylinders matched with the fastening circular holes.

Preferably, the detachable component of the automatic wok pan is arranged at openings at both ends of the pan body, and includes a fixing buckle fixedly arranged on an outer surface of the notch at both ends of the pan body, and a push button arranged in the shell and the force arm; an upper end of the push button moves in the push groove, and a lower end of the push button is connected with a slider, and a lower end of the left side of the slider is provided with an inverted fixture block matched with the fixing buckle.

Preferably, a switch for turning on and off equipment is arranged on one side of the force arm near the battery of an automatic wok pan, and a charging interface for charging is arranged below the switch.

Preferably, the stirring component of the automatic wok pan includes a flange for connecting the transmission component, a stirring shaft for connecting the flange, and stirring blades arranged at the bottom of the stirring shaft.

Preferably, a battery is arranged in the force arm of the automatic wok pan at one end far from the pan body.

Preferably, the transmission mode of the transmission component is bevel gear transmission.

Preferably, the bevel gear transmission includes a long shaft connected with the motor, and the long shaft passes through a gear block for fixing, and a first bevel gear is also arranged at the joint of the long shaft and the gear block near the right side; the gear block is a gear block with a circular groove in the middle; a first bearing is arranged at an upper end of the circular groove of the gear block, and a second bearing is arranged at a lower end of the circular groove; the first bearing is provided with a second bevel gear, and the first bevel gear is engaged with the second bevel gear; the second bevel gear, the first bearing and the second bearing are all penetrated by a short shaft; the second bevel gear is connected and fixed with an upper end of the short shaft, and a lower end of the short shaft is connected with the flange for controlling and fixing the stirring component.

Preferably, the transmission component is chain or belt transmission.

The automatic wok pan provided by the present application has the following advantages:

The pan body is provided with two notches, and then the fixing buckles arranged on the notches are buckled and matched with the detachable components on the force arm, so that the force arm can be detached or fixed on the pan body at any time, therefore the force arm can be detached for convenient cleaning; since the height of the force arm does not exceed the notches on the pan body, the lid can be covered or opened at any time to add materials; and at the same time, because the power supply is a rechargeable battery, it can be used in various scenarios.

In addition, as items such as condiments or side dishes need to be added at any time, the wok pan of the application can realize cooking without a lid. At the same time, because the force arm is flush with the notch of the pan body, it can also be covered with a lid to realize cooking.

### BRIEF DESCRIPTION OF DRAWINGS

FIG. 1 is a perspective view of a wok pan provided by the present application;

FIG. 2 is a bottom view provided by the present application;

FIG. 3 is an exploded view of the shell provided by the present application;

FIG. 4 is a bottom view of the explosion bottom of the shell provided by the present application;

FIG. 5 is an enlarged view of the detachable component provided by the present application;

FIG. 6 is an enlarged view of the bevel gear structure provided by the present application;

FIG. 7 is a perspective view of the chain transmission provided by the present application;

FIG. 8 is an exploded view of the chain transmission housing provided by the present application.

In the figures: 1, Pan body; 2, Shell; 21, Push groove; 22, Circular groove; 23, Clamping groove; 3, Force arm; 31, Switch; 32, Charging interface; 33, Motor; 34, Clamping block; 35, Fastening cylinder; 4, Power supply; 5, Fixing buckle; 6, Detachable component; 61, Push button; 62, slider; 63, Inverted clamping block; 7, Transmission component; 71, Long shaft; 72, Gear block; 73, First bevel gear; 74, First bearing; 75, Second bearing; 76, Second bevel gear; 77, Short shaft; 8, Stirring component; 81, Stirring shaft; 82, Stirring blades; 83, Flange.

### DESCRIPTION OF EMBODIMENTS

In order to make the purpose, technical solution and advantages of the present application more clear, the present application will be further explained in detail with the attached drawings and examples. It should be understood that the specific embodiments described here are only used to explain the present application, and are not used to limit the present application.

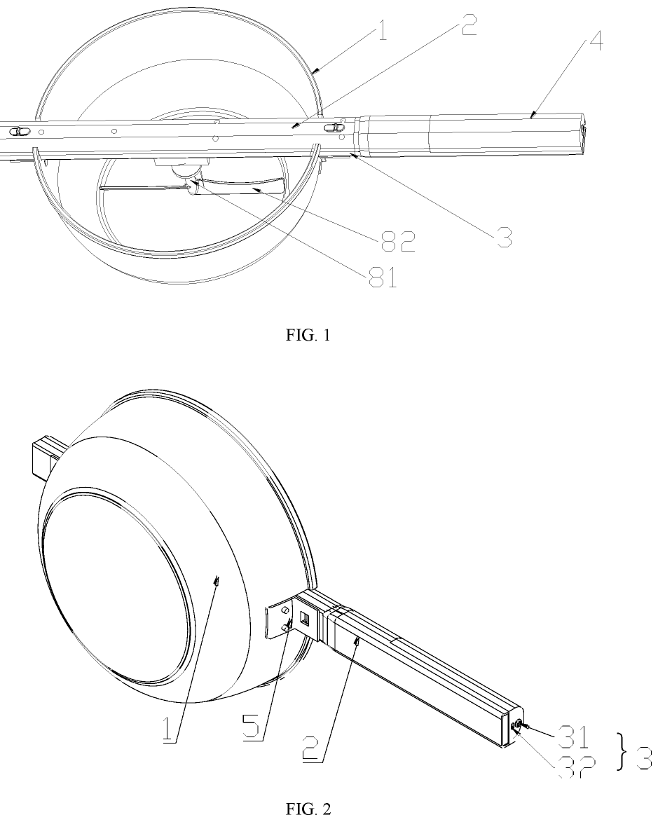

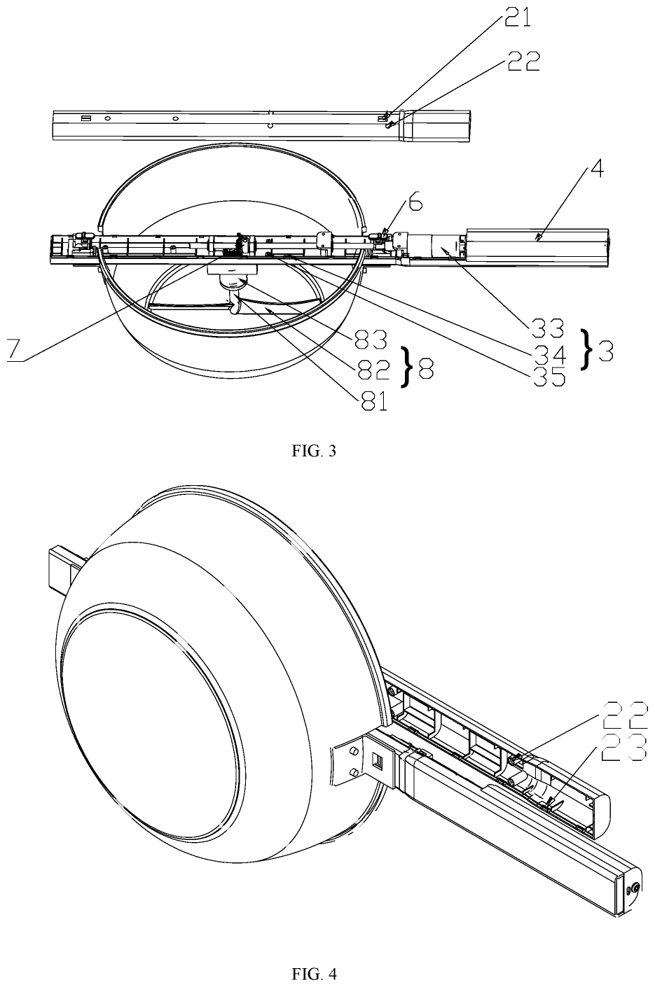

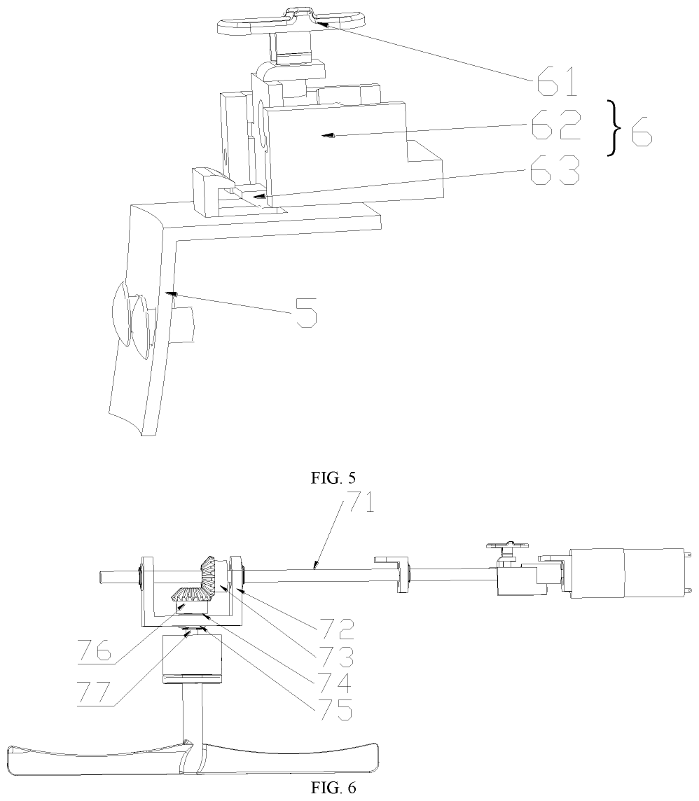

In Embodiment 1, referring to FIGS. 1 to 5, the present application provides an automatic wok pan, which includes a pan body 1, wherein the upper end of the pan body 1 is provided with two notches; the upper end of the pan body 1 is provided with a force arm 3; the upper end of the force arm 3 is provided with a shell 2; the force arm 3 and the shell 2 are arranged on the pan body 1 through the notches at the upper end of the pan body 1; and the shell 2 and the force arm 3 are detachably fixed on the pan body 1 through a detachable component 6; the height of the force arm 3 is not more than the height of the notch of the pan body 1, and the right side of the force arm 3 is provided with a power supply 4, and the left side of the battery is connected with a motor 33; the power supply 4 and the motor 33 are far away from the pan body 1, and the other side of the motor 33 is connected with a transmission component 7; the tail end of which is connected with a stirring component 8, and the stirring component 8 is fixed at the center of the pan body 1 through the force arm 3. By providing two notches in the pan body 1, the force arm 3 is placed on the notches of the pan body 1, and the detachable component 6 is provided, thereby achieving the effect of fixing and detaching the force arm 3 through the detachable component 6.

Furthermore, the force arm 3 further includes a shell 2 arranged on the upper surface; the automatic wok pan further includes circular grooves 22 evenly distributed on the shell 2, and fastening circular holes are arranged on the shell 2 near the notches at both ends of the pan body 1; push grooves 21 are arranged on the notches of the shell 2 near the pan body 1, and clamping grooves 23 are arranged on both sides of the lower end of the shell 2. Both sides of the upper surface of the force arm 3 are provided with clamping blocks 34 corresponding to the clamping grooves 23, and the upper surface of the force arm 3 is also provided with fastening cylinders 35 matched with the fastening circular holes. Through the cooperation between the clamping grooves 23 and the clamping blocks 34, the shell 2 and the force arm 3 can achieve the effect of initial fixture, and the fastening circular holes and the fastening cylinders 35 can be fixed for further fixation. Through the double fixation, the cooking fume in the wok pan can be effectively reduced from entering the cavity between the shell 2 and the force arm 3 during cooking, thus affecting the normal operation of the motor 33 and the transmission device.

Further, the detachable component 6 on an automatic wok pan is arranged at the openings at both ends of the pan body 1, and includes a fixing buckle 5 fixedly arranged on the outer surface of the notch at both ends of the pan body 1, and a push button 61 arranged in the shell 2 and the force arm 3; the upper end of the push button 61 moves in the push groove 21, the lower end of the push button 61 is connected with a slider 62, and the lower end of the left side of the slider 62 is provided with an inverted fixture block 63 matched with the fixing buckle 5. When the device is fixed and disassembled, the push button 61 is pressed downward to make the inverted fixture block 63 and the fixing buckle 5 buckle automatically, thus achieving the fixing effect. When it needs to be removed, the push button 61 must be pushed first to take it down. By pressing or pushing the push button 61 in the push groove 21, the inverted fixture block and the fixing buckle 5 are fastened or pulled apart, thus achieving the purpose of fixing or disassembling the force arm 3.

Further, the power supply 4 of the automatic wok pan is a rechargeable battery. When the battery is fully charged, the wok pan can be started at any time, which is convenient and practical, and solves the dilemma that the wok pan must be connected with the power cord when frying.

Further, the force arm 3 of the automatic wok pan is provided with a switch 31 for turning on and off equipment near the battery, and a charging interface 32 for charging is provided below the switch 31. The power supply 4 is turned on or off by turning on or off the switch 31, and the battery is charged through the charging interface 32.

Furthermore, a battery 4 is arranged at the end of the force arm 3 far from the pan body 1, and the battery 4 can be charged through the charging interface 32.

Further, the stirring component 8 of the automatic wok pan includes a stirring shaft 81 for connecting the transmission component 7, and stirring blades 82 arranged at the bottom of the stirring shaft 81. When the wok pan is started, the stirring shaft 81 is driven by the transmission component 7, and the stirring blades 82 are driven along with the transmission of the stirring shaft 81, thus achieving the effect of automatic cooking.

Further, the transmission mode of the transmission component 7 of the automatic wok pan is bevel gear transmission. The bevel gear transmission comprises a long shaft 71 connected with the motor 33, and the long shaft 71 passes through a gear block 72 for fixing, and a first bevel gear 73 is also arranged at the joint of the long shaft 71 and the gear block 72 near the right side; the gear block 72 is a gear block 72 with a circular groove in the middle; a first bearing 74 is arranged at an upper end of the circular groove of the gear block 72, and a second bearing 75 is arranged at a lower end of the circular groove; the first bearing is provided with a second bevel gear 76, and the first bevel gear 73 is engaged with the second bevel gear 76; the second bevel gear 76, the first bearing 74 and the second bearing 75 are all penetrated by a short shaft 77; the second bevel gear 76 is connected and fixed with an upper end of the short shaft 77, and a lower end of the short shaft 77 is connected with the flange 83 for controlling and fixing the stirring component 8. Bevel gear transmission has the advantages of strong bearing capacity, high mechanical properties, and long service life.

To sum up, the specific working principle of the present application is as follows: when it needs to be used, firstly, the force arm is placed on the pan body 1 through the notch on the pan body 1, and the push button 61 is pressed down to control the detachable component 6 to be buckled and matched with the fixing buckle 5 at the notch on the pan body 1, and then the force arm is fixed on the notch on the pan body 1; then the switch 31 is turned on, and the motor 33 is started with the power supply 4, and then the kinetic energy is transferred to the transmission component 7, which drives the stirring component 8. During cooking, automatic cooking can be realized without manual stir-frying, and the wok pan of the application can achieve cooking without the lid since it needs to add condiments or side dishes at any time.

It should be noted that, because the force arm of force 3 is flush with the notch of the pan body 1, it is also possible to cover the pan with a lid to realize cooking.

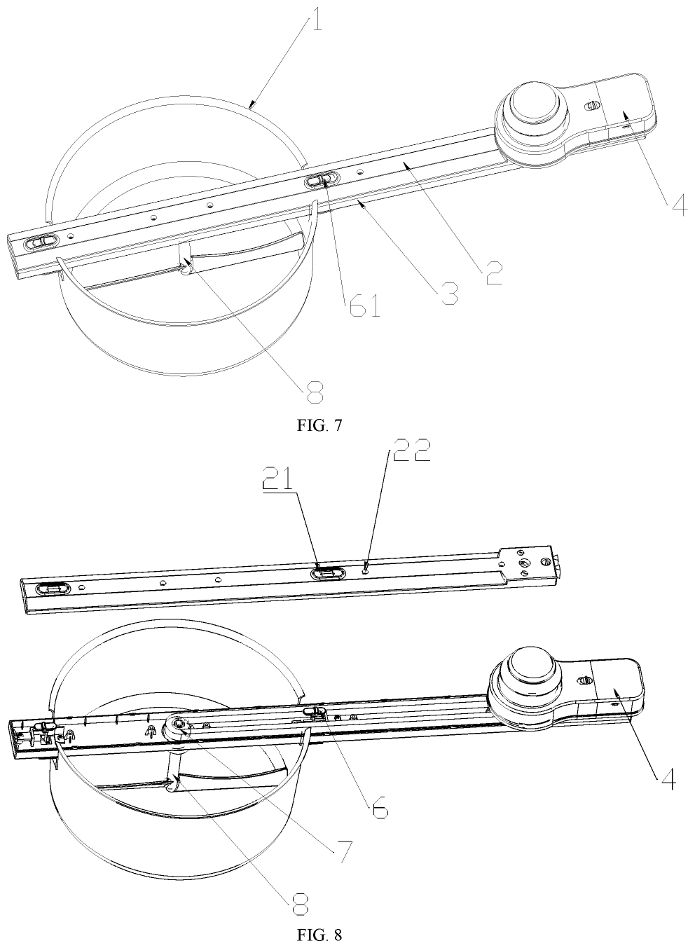

In Embodiment 2, referring to FIG. 7 to FIG. 8, the embodiment of the present application also provides an automatic wok pan. The transmission mode of the transmission component 7 is chain transmission. The chain transmission component includes a rotating shaft connected below the motor, the other end of the rotating shaft is connected with a first gear; a chain is arranged between the force arm and the shell, the right end inside the chain is engaged with the first gear, and the left end inside the chain is provided with a second gear, which is engaged with the left end inside the chain; the second chain is connected with the upper end of a short shaft, and the lower end of the short shaft is connected with a flange. The power supply is turned on to start the motor to drive the first gear to rotate, and the chain drives the second gear to rotate through the first gear, so that the stirring component starts to rotate and stir, and the automatic cooking function is realized.

Chain transmission has the advantages of high bearing capacity, and is suitable for harsh working environment and has high efficiency and small force acting on the shaft.

The automatic wok pan provided by the present application has the following advantages:

The pan body is provided with two notches, and then the fixing buckles arranged on the notches are buckled and matched with the detachable components on the force arm, so that the force arm can be detached or fixed on the pan body at any time, so that the force arm can be detached for convenient cleaning; and since the height of the force arm does not exceed the notches on the pan body, the pan can be covered or opened at any time to add materials, and at the same time, because the battery is a rechargeable battery, the pan can be used in various scenarios.

The above is only the preferred embodiment of this present application, and it is not used to limit this present application. Any modification, equivalent substitution and improvement made within the spirit and principle of this present application should be included in the protection scope of this present application.

What is claimed is:

1. An automatic wok pan, comprising a pan body (1) and a force arm (3) crossing an upper end of the pan body (1), wherein the upper end of the pan body (1) is provided with a notch for accommodating the force arm (3), and the force arm (3) is connected to the pan body (1) through a detachable component (6); the force arm (3) is provided with a motor (33), and a transmission component (7) is arranged in the force arm (3); a tail end of the transmission component (7) is connected with a stirring component (8), and the stirring component (8) is arranged in the center of the pan body (1).

2. The automatic wok pan according to claim 1, wherein the motor (33) is arranged at an end of the force arm (3) far away from the pan body (1), and the motor (33) drives the stirring component (8) through the transmission component (7).

3. The automatic wok pan according to claim 1, wherein the force arm further comprises a shell (2) arranged on an upper surface, and circular grooves (22) are uniformly distributed on the shell (2); push grooves (21) are arranged at a notch of the shell (2) close to the pan body (1), and both sides of a lower end of the shell (2) are provided with clamping grooves (23), both sides of the upper surface of the force arm (3) are provided with clamping blocks (34) corresponding to the clamping grooves (23); and the upper surface of the force arm (3) is further provided with a fastening cylinder (35) matched with the circular grooves (22).

4. The automatic wok pan according to claim 3, wherein the detachable component (6) is arranged at openings at both ends of the pan body (1), and comprises a fixing buckle (5) fixedly arranged on an outer surface of the notch at both ends of the pan body (1), and a push button (61) arranged in the shell (2) and the force arm (3); an upper end of the push button (61) moves in the push groove (21), and a lower end of the push button (61) is connected with a slider (62), and a lower end of the left side of the slider (62) is provided with an inverted fixture block (63) matched with the fixing buckle (5).

5. The automatic wok pan according to claim 1, wherein a switch (31) for turning on and off equipment is arranged on one side of the force arm (3) near a battery, and a charging interface (32) for charging is arranged below the switch (31).

6. The automatic wok pan according to claim 1, wherein the stirring component (8) comprises a flange (83) for connecting the transmission component (7), a stirring shaft (81) and stirring blades (82) arranged at the bottom of the stirring shaft (81) are connected below the flange (83).

7. The automatic wok pan according to claim 1, wherein a battery (4) is arranged at one end in the force arm (3) far from the pan body (1).

8. The automatic wok pan according to claim 1, wherein the transmission mode of the transmission component (7) is bevel gear transmission.

9. The automatic wok pan according to claim 8, wherein the bevel gear transmission comprises a long shaft (71) connected with the motor (33), and the long shaft (71) passes through a gear block (72) for fixing, and a first bevel gear (73) is also arranged at the joint of the long shaft (71) and the gear block (72) near the right side; the gear block (72) is a gear block (72) with a circular groove in the middle; a first bearing (74) is arranged at an upper end of the circular groove of the gear block (72), and a second bearing (75) is arranged at a lower end of the circular groove; the first bearing is provided with a second bevel gear (76), and the first bevel gear (73) is engaged with the second bevel gear (76); the second bevel gear (76), the first bearing (74) and the second bearing (75) are all penetrated by a short shaft (77); the second bevel gear (76) is connected and fixed with an upper end of the short shaft (77), and a lower end of the short shaft (77) is connected with the flange (83) for controlling and fixing the stirring component (8).

10. The automatic wok pan according to claim 1, wherein the transmission component (7) is chain or belt transmission.
